(19) United States
(12) Patent Application Publication
(10) Pub. No.: US 2026/0308065 A1
(43) Pub. Date: Oct. 8, 2026

(54) PROCESS FOR OBTAINING FIBRE-REINFORCED COMPOSITE MATERIALS

(71) Applicant: AERONAUTICAL SERVICE S.R.L., FIUMICINO (IT)

(72) Inventors: Cristiano BORDIGNON, FIUMICINO (IT); Marescotti RUSPOLI, FIUMICINO (IT)

(73) Assignee: AERONAUTICAL SERVICE S.R.L., FIUMICINO, RM (IT)

(21) Appl. No.: 19/479,017

(22) PCT Filed: Apr. 24, 2024
(86) PCT No.: PCT/IT2024/050078

§ 371 Date: Oct. 27, 2025

(30) Foreign Application Priority Data
Apr. 27, 2023 (IT) 102023000008205
Sep. 5, 2023 (IT) 102023000018228

(51) Int. Cl. C04B 28/26; C04B 14/06; C04B 14/10; C04B 14/32; C04B 14/38; C04B 40/00; C04B 111/00; C04B 111/28

(52) U.S. Cl. CPC C04B 28/26; C04B 14/062; C04B 14/106; C04B 14/324; C04B 14/386; C04B 40/0071; C04B 40/0082; C04B 2111/00853; C04B 2111/28; C04B 2201/20

(57) ABSTRACT

A process for obtaining a flame-resistant fibre-reinforced composite material or laminate of a fibre-reinforced composite material includes obtaining an inorganic matrix by mixing 70% to 80% by weight of an alkaline silicate component, 20% to 30% by weight of a mixture of an amorphous silica component and an aluminosilicate component; pre-impregnating a reinforcing fibre, thereby obtaining a pre-impregnated composite material; and subjecting the pre-impregnated composite material for a time ranging from 90 minutes to 12 minutes. The embodiments also relate to a composite material obtained from the previously defined process, and a process for producing an inorganic matrix for the production of a flame-resistant fibre-reinforced composite material and an inorganic matrix obtained from the process.

### FIELD

The present invention relates to a process for obtaining fibre-reinforced composite materials.

In particular, the present invention relates to a process for obtaining and curing flame-resistant fibre-reinforced composite materials comprising an inorganic matrix.

### BACKGROUND

It is well known that the phases (or the base materials) of a composite material are at least one reinforcement and at least one matrix.

The reinforcement, which can be for example a reinforcing fibre, is represented by a dispersed phase which has the function of assuring rigidity and mechanical strength, bearing most of the working load.

Generally, the matrix consists of a homogeneous phase which has the function of enclosing the reinforcement, ensuring the cohesion of the composite material, and homogenising the dispersion of particles or reinforcing fibres within the composite, avoiding segregation phenomena.

It is well known that fibre-reinforced composite materials having inorganic matrices, in particular ceramic matrices, are resistant to high temperatures.

For example, patent application WO 2018/179019 describes a method for obtaining an inorganic matrix for the production of fibre-reinforced composite materials resistant to high temperatures, wherein the composite material obtained with the aforesaid matrix, besides having good mechanical capacities, is characterised by a limited weight and thickness and a structural resistance to oxidation, which is characteristic of high-temperature environments.

However, it is also known that the known processes for the production of fibre-reinforced composite materials comprising inorganic matrices, in particular belonging to the family of water-based inorganic polymers of the alkaline polysialate type, also known as geopolymers or preceramic polymers, entail extremely long and burdensome thermal and baric curing cycles.

In particular, in the known curing processes, a first low-temperature curing and subsequent high-temperature curing (or post-curing) are carried out.

The first low-temperature curing provides for slow drying at temperatures of between 40° C. and 80° C. for over 8 hours and, in any case, always below the boiling temperature of the aqueous solution (for example, in the specific case of potassium silicate, the boiling temperature is about 103° C.). This process provides for slow evaporation of the aqueous base, with the aim of gradually initiating the polymer crosslinking processes, with the dispersion of inorganic powders.

Once the drying step has ended, a post-curing, also defined as “ceramisation”, is generally provided for, conducted at temperatures ranging from 600° C. to over 1000° C., to initiate the ceramisation of the elements making up the matrix. The ceramisation step is necessary to impart to the product characteristics of fire resistance and, more in general, resistance to temperatures higher than 800° C. This step is carried out in the presence of an inert gas, in order not to oxidate the fibre reinforcement component, typically consisting of carbon fibre or silicon carbide fibre. However, despite this, the ceramisation step can in any case result in partial oxidation of the reinforcing fibre.

More specifically, a classic cycle of curing a laminate with a fibre reinforcement and matrix composed of a preceramic polymer or geopolymer comprises the following steps:
a) a first curing step, carried out in an autoclave or under a press, with pressure values comprised between 2 bar and 10 bar, or at atmospheric pressure, with temperatures comprised between 40° C. and 80° C.; said first curing step may possibly take place in a vacuum for 12 hours;
b) a second air-drying step at a temperature of 80° C. for 6 hours;
c) a third post-curing step, wherein the material is ceramicised at temperatures comprised between 700° C. and 1000° C.

For example, the above-mentioned patent application WO2018/179019 describes a specific curing process comprising a first curing step at temperatures comprised between 40° C. and 80° C. and at a pressure of between 1 and 10 bar; a second post-curing step at temperatures comprised between 100° C. and 900° C., obtaining in this step a material characterised by a porosity of between 20% and 30%; a third impregnation step; a fourth curing step; and a fifth post-curing step at temperatures comprised between 250° C. and 900° C.

As indicated above, by applying the known process described above, one obtains laminates with a porosity ranging from 20% to 30%. In this regard, in patent application WO2018/179019 it is described that, in order to obtain lower porosity values, which are more advantageous as they decrease the hygroscopicity of the material, the third impregnation step, the fourth curing step and the fifth post-curing step can be repeated a certain number of times until the desired porosity is obtained. Therefore, according to the prior art, in order to obtain lower porosities, it is necessary to repeat the standard curing steps, which are already in themselves very long and energy-intensive, a number of times.

Based on the above, the long curing at low temperatures and possible post-curing to obtain of a fibre-reinforced material for obtaining products resistant to high temperatures, in particular temperatures in the order of 1000° C., make such products difficult to commercialise. In particular, this is due to:
long duration of the curing cycle, which translates into a low productivity for every single piece of equipment produced;
high energy cost of the curing cycle, due in particular to the necessity of having ovens dedicated to post-curing operating in the presence of inert gas and at high working temperatures (over 600° C.), which have rather high purchase and operating costs.

Therefore, although the fibre-reinforced products described above have a high commercial interest, by virtue of their characteristics of light weight and resistance to very high temperatures, such materials do not have application in sectors characterised by high production rates, such as, for example, the automotive industry and the aeronautical industry, in particular the aerostructures industry. In particular, although fibre-reinforced materials with carbon fibre and geopolymer resins have an advantageous application in these sectors, the use of the curing cycles described above lengthens production times and proves to be particularly burdensome. In fact, such sectors are characterised by the necessity of producing a large amount of products. To give an example, the Airbus company builds about 500 aircraft per year and needs four hatches for each, for a total of 2000 products per year. As regards the automotive industry, on the other hand, it is known that the duration of a cycle for moulded parts is at most 15 minutes per piece produced, typically from 3 to 12 minutes. As is well known, this is determined by the necessity of satisfying production needs quantifiable as 20,000-100,000 parts per year, for the high-end auto sectors alone.

### SUMMARY

In the light of the above, it appears evident that there is a need to provide new composite materials and new processes for the production of composite materials capable of overcoming the disadvantages of the known materials and processes.

The solution according to the present invention fits into this context; it aims to provide a new process for the production of a fibre-reinforced composite material comprising an inorganic matrix.

In particular, according to the present invention it has now been found that, by using a preceramic inorganic matrix characterised by a new composition and subjecting the provisional composite material (so-called pre-impregnated material, i.e. the material consisting of the reinforcement and the inorganic matrix) to a single curing step, with given temperature and pressure conditions, it is possible to obtain a flame-resistant fibre-reinforced composite material, characterised by better mechanical properties and less porosity than materials obtained with the known processes.

More in particular, according to the process of the present invention, the provisional composite material is not subjected to the classic ceramisation step, but is rather subjected to a single curing step, characterised by very low pressure and temperature values compared to the values used in the known processes. The preceramic inorganic matrix used according to the present invention, when subjected to the curing process according to the invention, is advantageously capable of imparting to the final product the same flame-retardant characteristics imparted by the classic known curing cycles. Furthermore, the final composite material obtained according to the present invention is advantageously characterised by a porosity of between 1.5 and 4%. The lower porosity renders the material less hygroscopic, according to regulations. In fact, the saturation absorption of the material obtained according to the present invention is about 1.80%.

Furthermore, compared to the products obtained with the known processes, the composite material obtained according to the present invention is characterised by better mechanical properties. For example, if use is made of a carbon fabric of the T700 Twill 2×2 type according to the axis of the fibre and according to standard ASTM D3039, the modulus of elasticity obtained according to the present invention is equal to 40 GPa, whilst, using the same material, the modulus obtained with the known process is equal to 30 GPa. Furthermore, the composite material according to the present invention is characterised by a tensile strength of 250 to 280 GPa, whereas with the known curing process one obtains materials characterised by a tensile strength of about 160 MPa.

The better mechanical characteristics of the material according to the present invention are determined in part by the increase in density. In fact, the specific weight of the product obtained with the known process is comprised in the range of 1.10 g/cm³ to 1.4 g/cm³, whereas with the process of the invention one obtains a product with a specific weight ranging from 1.55 to 1.65 g/cm³. However, considering the specific resistance of the material, the product obtained with the process according to the invention proves overall to be more advantageous compared to the known products.

Furthermore, according to the present invention, thanks to the elimination of the ceramisation process, the reinforcing fibres are not partly oxidated as occurs, by contrast, with the use of the known processes.

### DETAILED DESCRIPTION OF EMBODIMENTS

According to the present invention, there is thus provided a new process for the production of fibre-reinforced composite materials which, compared to the known processes:
is characterised by an exceptionally shorter curing time;
is capable of imparting better mechanical characteristics to the final material;
can be used in environments characterised by contact with liquids: this quality depends on the lower porosity and thus the lower possibility of absorption of the liquids with which the material comes into contact.

Therefore, the process according to the present invention is extremely advantageous compared to known curing process used for preceramic polymers.

Thus, a first specific object of the present invention is a process for obtaining a flame-resistant fibre-reinforced composite material or laminate of a fibre-reinforced composite material, said process comprising the following steps
a) obtaining an inorganic matrix by mixing
   70% to 80% by weight of an alkaline silicate component, preferably chosen from the group consisting of caesium (Cs) silicate, sodium (Na) silicate or potassium (K) silicate, more preferably potassium (K) silicate, said silicate component being present in an aqueous solution;
   20% to 30% by weight of a mixture of an amorphous silica component and an aluminosilicate component, for example a reactive aluminosilicate powder, with a silica to aluminosilicate component weight ratio of between 5:1 and 25:1;
b) pre-impregnating a reinforcing fibre, preferably chosen from the group consisting of carbon fibre, basalt fibre and glass fibre, more preferably carbon fibre, with the inorganic matrix obtained in step a), thereby obtaining a pre-impregnated composite material, for example a laminate of a pre-impregnated composite material;
c) subjecting the pre-impregnated composite material obtained in step b) to a pressure ranging from 3 to 20 bar and a temperature ranging from 180° C. to 220° C., for a time ranging from 90 minutes to 12 minutes.

According to one embodiment of the present invention, said step c) comprises
subjecting the material to a temperature of about 220° C. for about 12 minutes or, according to an alternative embodiment, to a temperature of about 180° C. for about 90 minutes.

Furthermore, according to the invention, said step a) can further comprise mixing, in addition to said alkaline silicate component, said amorphous silica component and said aluminosilicate component, 1% to 3.5% by weight of beta silicon carbide, preferably in the form of nanoparticles.

Preferably, according to the invention, said amorphous silica component has an average particle size ranging from 0.01 microns to 15 microns and is chosen from the group consisting of thermal silica, fused silica or pyrogenic silica, preferably fused silica.

According to a preferred embodiment of the present invention, said amorphous aluminosilicate component is stoichiometrically controlled by means of an Al₂O₃×2 SiO₂ composition.

Therefore, according to the process of the present invention, in said step a) an original aqueous-based inorganic polymer of the alkaline polysialate type, belonging to the family of geopolymers (also definable as a preceramic polymer), is produced, which is then used in said step b) to impregnate a reinforcing fibre, such as, for example, woven or nonwoven carbon fibre, and, finally, the pre-impregnated composite material is subjected to the curing step described in step c).

The present invention also relates to a flame-resistant fibre-reinforced composite material, obtainable through the previously defined process and comprising:
40% to 60% by weight of a reinforcing fibre preferably chosen from the group consisting of carbon fibre, basalt fibre and glass fibre, preferably carbon fibre,
70% to 80% by weight of an inorganic matrix comprising an alkaline silicate component chosen from the group consisting of caesium (Cs) silicate, sodium (Na) silicate or potassium (K) silicate, preferably potassium (K) silicate, and
20% to 30% by weight of an amorphous silica component and an aluminosilicate component, for example a reactive aluminosilicate powder; and also preferably wherein said inorganic matrix further comprises 1% to 3.5% by weight of beta silicon carbide nanoparticles.

According to the invention, said amorphous silica component preferably has an average particle size ranging from 0.01 microns to 15 microns and is chosen from the group consisting of thermal silica, fused silica or pyrogenic silica, preferably fused silica; moreover, said composite material can have a specific weight ranging from 1.4 g/cm³ to 1.7 g/cm³, for example from 1.55 to 1.65 g/cm³; and a porosity ranging from 2% to 4%.

A further specific object of the present invention is a process for obtaining an inorganic matrix for the production of a flame-resistant fibre-reinforced composite material, said process comprising mixing:
70% to 80% by weight of an alkaline silicate component preferably chosen from the group consisting of caesium (Cs) silicate, sodium (Na) silicate or potassium (K) silicate, more preferably potassium (K) silicate, in the form of an aqueous solution with
20% to 30% by weight of a mixture of an amorphous silica component and an aluminosilicate component, for example a reactive aluminosilicate powder, with a silica to aluminosilicate component weight ratio of between 5:1 and 25:1.

In particular, according to the invention, said process can further comprise mixing, in addition to said alkaline silicate component and said mixture of an amorphous silica component and aluminosilicate component, from 1% to 3.5% by weight of beta silicon carbide, preferably in the form of nanoparticles.

Furthermore, according to the invention, preferably said amorphous silica component has an average particle size ranging from 0.01 microns to 15 microns and is chosen from the group consisting of thermal silica, fused silica or pyrogenic silica, preferably fused silica.

According to a preferred embodiment of the present invention, said aluminosilicate component is stoichiometrically controlled by means of an Al₂O₃×2SiO₂ composition.

The present invention further relates to an inorganic matrix obtainable through the previously defined process, said matrix comprising 70% to 80% by weight of an alkaline silicate component chosen from the group consisting of caesium (Cs) silicate, sodium (Na) silicate or potassium (K) silicate, preferably potassium (K) silicate; 20% to 30% by weight of a mixture of an amorphous silica component and an aluminosilicate component, for example a reactive aluminosilicate powder.

Preferably, according to the invention, said inorganic matrix further comprises from 1% to 3.5% by weight of beta silicon carbide, more preferably in the form of nanoparticles; and said amorphous silica component has an average particle size ranging from 0.01 microns to 15 microns and is chosen from the group consisting of thermal silica, fused silica or pyrogenic silica, preferably fused silica.

The present invention will now be described by way of non-limiting illustration according to a preferred embodiment thereof, with particular reference to the examples and the figures in the appended drawings, in which:

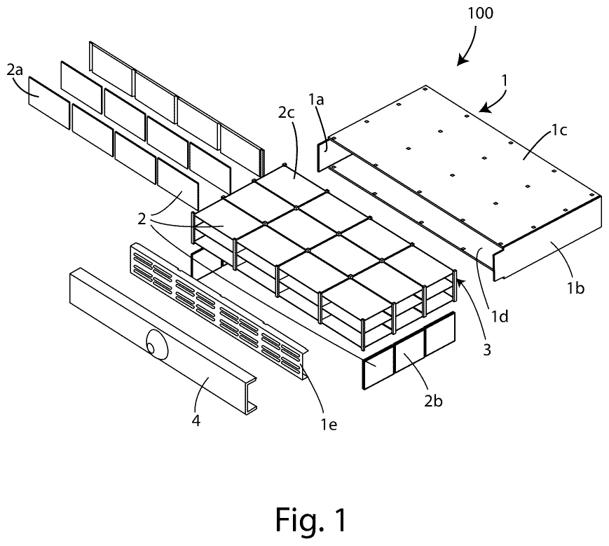

FIG. 1 shows an exploded view of a container of lithium-ion battery packs comprising a cell separator made of the composite material according to the present invention, as described in Example 3.

### EXAMPLE 1

### Example of a Process for Producing and Curing the Composite Material According to the Present Invention

An inorganic matrix was obtained by mixing fused silica in an amount of 23% with metakaolin (an amorphous aluminosilicate component) in an amount of 1%-2% in a 75% solution of potassium silicate, wherein said percentages are percentages by weight relative to the total weight of the matrix obtained.

A T 700 3K twill 2×2 carbon fabric was subsequently impregnated with the previously obtained inorganic matrix, thereby obtaining a provisional composite material, also called pre-impregnated material.

The pre-impregnated composite material was subsequently subjected to a pressure of 7-70 bar and to a temperature of 220° C. for a time of 12 minutes.

The laminate of composite material obtained was characterised by the following mechanical properties:
specific weight: 1.6 g/m³;
elastic modulus: GPa; 40
tensile strength: 280 Mpa;
thermal conductivity: 0.3 W/Kom;
porosity 2.5%.

### EXAMPLE 2

### Example of a Process for Producing and Curing the Composite Material According to the Present Invention

An inorganic matrix was obtained by mixing fused silica in an amount of 21% and metakaolin in an amount of 1% in a solution of caesium silicate in an amount of 75.5% and Beta SiC (beta silicon carbide) in an amount of 2.5%, wherein said percentages are percentages by weight relative to the total weight of the matrix obtained.

A T 700 3K twill 2×2 carbon fabric was subsequently impregnated with the previously obtained inorganic matrix, thereby obtaining a provisional composite material, also called pre-impregnated material.

The pre-impregnated composite material was subsequently subjected to a pressure of 7 bar and to a temperature of 220° C. for a time of 12 minutes.

The laminate of composite material obtained was characterised by the following mechanical properties:
specific weight: 1.6 g/m³;
elastic modulus: 40 GPa;
tensile strength: 295 Mpa;
thermal conductivity: 0.27 W/mK.

Compared to the mixture obtained with example 1, by introducing beta SiC one decreases the thermal conductivity, which goes from 0.3 W/mK to 0.27 W/mK, with the advantage of better thermal insulation characteristics.

### EXAMPLE 3

### Example of Application of the Composite Material According to the Present Invention

The composite material obtained in example 2 was used to produce several parts of a container of lithium-ion battery packs.

In particular, FIG. 1 shows a container of lithium-ion battery packs 100 comprising a container 1, consisting of two lateral walls 1a and 1b, an upper wall 1c, a lower or base wall 1d, a rear wall and a front closure wall 1e, comprising a lithium-ion cell separator 2.

The lithium-ion cell separator 2 is composed of walls 2a, 2b, 2c placed between one pack of cells and the other, supported by a structure 3. The separator has the aim of preventing, in the event of explosion of a pack of cells, the adjacent pack of cells from having the same fate.

The front part of the battery pack has a release of the explosion towards a pressure chamber (plenum chamber) through the venting channel 4.

All the walls 2a, 2b, 2c of the separator 2 placed between the packs of lithium cells and all the walls 1a, 1b, 1c, 1d, 1e of the container were fabricated with the material and the process of example 2.

The composite material of the invention ensures that, in the event of an explosion of a pack of cells or a single cell or all the cells, no contamination of the surrounding environment occurs in terms of fumes or odorous gases and that the external temperature of the battery container is less than or equal to 220° C.

Typically, such an explosion generates pressures comprised between 4 and 10 bar, temperatures between 1400° C. and 1800° C. and the release of fused lithium on the surface. Conservatively, in the thermo-fluid-dynamic calculation it is considered that the segregators of packs of lithium-ion cells and the covers thereof must resist without deteriorating with temperatures between 1400° C.-1800°C. for a time of 6 seconds, at most 8, with an internal pressure comprised between 4 and 6 bar.

The material according to the invention has shown properties of resistance to high temperatures after having been subjected to the above-specified temperatures characteristic of an explosion. It was in fact possible to verify that the material, after the explosion resulting from the thermal runaway, did not undergo morphological alterations, even in zones where fused lithium was deposited. In order to verify its resistance to the fire event, the sample was subjected to a flame exposure test, 1200° C. and 120 KW/m² of thermal flow and maintained its qualities of thermal conductivity unchanged and equal to 0.27 W/mK. When tested on the universal test machine, the material showed an approximately 60% loss of mechanical characteristics.

The present invention has been described by way of non-limiting illustration according to the preferred embodiments thereof, but it is to be understood that variations and/or modifications can be introduced by the person skilled in the art without going outside the scope of protection thereof, as defined by the appended claims.

1-14. (canceled)

15. A method for obtaining a flame-resistant fibre-reinforced composite material, the method comprising steps of:
a) obtaining an inorganic matrix by mixing
70% to 80% by weight of an alkaline silicate component, said silicate component being present in an aqueous solution; and
20% to 30% by weight of a mixture of an amorphous silica component and an aluminosilicate component, with a silica to aluminosilicate component weight ratio of between 5:1 and 25:1;
b) pre-impregnating a reinforcing fibre, with the inorganic matrix obtained in step a), thereby obtaining a pre-impregnated composite material; and
c) subjecting the pre-impregnated composite material obtained in step b) to a pressure ranging from 3 to 20 bar and a temperature ranging from 180° C. to 220° C., for a time ranging from 90 minutes to 12 minutes.

16. The method according to claim 15, wherein said step a) further comprises mixing, in addition to said alkaline silicate component, said amorphous silica component and said aluminosilicate component, 1% to 3.5% by weight of beta silicon carbide.

17. The method according to claim 15, wherein said amorphous silica component has an average particle size ranging from 0.01 microns to 15 microns and is chosen from the group consisting of thermal silica, fused silica or pyrogenic silica.

18. A flame-resistant fibre-reinforced composite material, comprising:
40% to 60% by weight of a reinforcing fibre chosen from the group consisting of carbon fibre, basalt fibre and glass fibre;
70% to 80% by weight of an inorganic matrix comprising an alkaline silicate component chosen from the group consisting of caesium (Cs) silicate, sodium (Na) silicate or potassium (K) silicate; and
20% to 30% by weight of a mixture of an amorphous silica component and an aluminosilicate component.

19. The composite material according to claim 18, wherein said inorganic matrix further comprises 1% to 3.5% by weight of beta silicon carbide nanoparticles.

20. The composite material according to claim 19, wherein said amorphous silica component has an average particle size ranging from 0.01 microns to 15 microns and is chosen from the group consisting of thermal silica, fused silica or pyrogenic silica.

21. The composite material according to claim 20, said composite material having a specific weight ranging from 1.4 g/cm³ to 1.7 g/cm³.

22. The composite material according to claim 21, said composite material having a porosity ranging from 2% to 4%.

23. A method for obtaining an inorganic matrix for the production of a flame-resistant fibre-reinforced composite material, said method comprising:
mixing
70% to 80% by weight of an alkaline silicate component chosen from the group consisting of caesium (Cs) silicate, sodium (Na) silicate or potassium (K) silicate, in the form of an aqueous solution with
20% to 30% by weight of a mixture of an amorphous silica component and an aluminosilicate component, with a silica to aluminosilicate component weight ratio of between 5:1 and 25:1.

24. The process according to claim 23, said process further comprising mixing, in addition to said alkaline silicate component and said mixture of an amorphous silica component and aluminosilicate component, 1% to 3.5% by weight of beta silicon carbide.

25. The process according to claim 24, wherein said amorphous silica component has an average particle size ranging from 0.01 microns to 15 microns and is chosen from the group consisting of thermal silica, fused silica or pyrogenic silica.

26. An inorganic matrix for the production of a flame-resistant fibre-reinforced composite material, said matrix comprising 70% to 80% by weight of an alkaline silicate component chosen from the group consisting of caesium (Cs) silicate, sodium (Na) silicate or potassium (K) silicate; 20% to 30% by weight of a mixture of an amorphous silica component and an aluminosilicate component.

27. The inorganic matrix according to claim 26, wherein said inorganic matrix further comprises 1% to 3.5% by weight of beta silicon carbide.

28. The inorganic matrix according to claim 27, wherein said amorphous silica component has an average particle size ranging from 0.01 microns to 15 microns and is chosen from the group consisting of thermal silica, fused silica or pyrogenic silica.
